(19) United States
(12) Patent Application Publication
(10) Pub. No.: US 2026/0187169 A1
(43) Pub. Date: Jul. 2, 2026

(54) CONTEXT-AWARE BROWSER TAB RECOMMENDATIONS

(71) Applicant: Microsoft Technology Licensing, LLC, Redmond, WA (US)

(72) Inventors: Kyle Matthew MILLER, Lynnwood, WA (US); Lasya Priya ANNADEVARA, Bothell, WA (US); Hariharan RAGUNATHAN, Woodinville, WA (US); Linjun SHOU, Beijing (CN)

(73) Assignee: Microsoft Technology Licensing, LLC, Redmond, WA (US)

(21) Appl. No.: 19/008,316

(22) Filed: Jan. 2, 2025

(51) Int. Cl. G06F 16/9535; G06F 3/04812; G06F 3/0483

(52) U.S. Cl. CPC G06F 16/9535; G06F 3/04812; G06F 3/0483

(57) ABSTRACT

The present technology relates to systems and methods that implement a framework for providing context-aware browser tab recommendations. The present framework allows a web browser to provide a user with recommended web pages in the form of browser tab shortcuts based on the content of the web page the user is currently viewing. When a user clicks on one of the browser tab shortcuts, a new tab is opened in the web browser to display the recommend web page. The browser tab shortcuts may be determined to anticipate the next website the user may want to view or other form of relevance.

### BACKGROUND

Web browsers are computing applications that provide access to the World Wide Web via the Internet. When a user requests a web page from a particular website, such as by sending a request with a Uniform Resource Locator (URL), the web browser retrieves the related content from a web server and displays the web page on the user's device. For instance, when the content is received from the web server, a rendering engine displays the content on a display of a computing device.

It is with respect to these and other considerations that examples have been made. In addition, although relatively specific problems have been discussed, it should be understood that the examples should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

The present technology relates to systems and methods that implement a framework for providing context-aware browser tab recommendations. While browsing the internet using a web browser, users may encounter content that they want to research or view further without leaving the current website. In this scenario, many users open a new tab, and begin a new search or visit another website without navigating away from the current website in the current tab. Users typically type in a new search query or URL to locate additional content.

The present framework enables a web browser to surface recommended web pages in the form of browser tab shortcuts based on the content of the web page that is currently being displayed. When a selection of one of the browser tab shortcuts is received, a new tab is opened in the web browser to display the recommend web page. The browser tab shortcuts may be determined to anticipate the next website the user may want to view. In some embodiments, a goal of the framework is to anticipate a user's goal and accelerate the navigation to a web destination without the receipt of manual entry of a search query or URL. Various types of data may be used in determining which web pages to recommend via the tab shortcut, including contextual information from the current web page as well as user profile data.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention. In the drawings:

FIG. 1A depicts an example web browser with a web page open.

FIG. 1B depicts the example web browser in which a hovering interaction is received over an interface element for opening a new tab and recommended tab shortcuts are displayed.

FIG. 1C depicts the example web browser in which a selection of one of the recommended tab shortcuts is about to be received.

FIG. 1D depicts the example web browser in which a selection of one of the recommended tab shortcuts is received and a corresponding web page is displayed in a new tab of the web browser.

FIG. 2 depicts an example system for implementing a framework for providing context-aware browser tab recommendations.

FIG. 3 depicts an example method for utilizing a framework for providing context-aware browser tab recommendations.

FIG. 4 depicts another example method for utilizing a framework for providing context-aware browser tab recommendations.

FIG. 5 depicts another example method for utilizing a framework for providing context-aware browser tab recommendations.

FIG. 6 depicts another example method for utilizing a framework for providing context-aware browser tab recommendations.

FIG. 7 is a block diagram illustrating example physical components of a computing device with which aspects of the technology may be practiced.

### DETAILED DESCRIPTION

The following detailed description refers to the accompanying drawings. Wherever possible, the same reference numbers are used in the drawing and the following description to refer to the same or similar elements. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the technology, but instead, the proper scope of the technology is defined by the appended claims. Examples may take the form of a hardware implementation, or an entirely software implementation, or an implementation combining software and hardware aspects. The following detailed description is, therefore, not to be taken in a limiting sense.

In some examples, a web browser includes a framework that provides context-aware browser tab recommendations in a web browser. In such a web browser, when an interaction (e.g., hover) with the new-tab button is received, browser tab shortcuts appear near the new tab button, such as where additional tabs may appear. The browser tab shortcuts represent links to additional web pages that may be of interest to the user, based on the content of the web page that is currently displayed (e.g., in an active tab). The specific web pages represented by the browser tab shortcuts are determined by the browser based on various factors. For example, contextual information of the web page in the active tab may be used to understand the content of the web page and used to recommend other useful web pages. A web-based application or service may summarize the content of the current web page through machine-learning (ML) or artificial intelligence (AI) models and generate the contextual information.

When a selection of a browser tab shortcut is received, a new tab is opened in the web browser and the corresponding web page is displayed in the new tab. This allows the web browser to anticipate web pages the user is most likely to visit next or webpages that the user may find useful. The browser is thus able to provide a quick and intuitive way to access these web pages, eliminating multiple interactions and page loads. The technology may also provide more useful content than might otherwise be obtained through more traditional browsing.

Additionally, present technology, among other things, generates context-aware browser tab recommendations, which when selected, not only open a recommended web page but also automatically take a desired action on the web page, such as conducting a search, submitting a prompt to a generative AI service, or adding/updating an item in a database. The framework may automatically determine the input values for the search or prompt based on contextual information of the web page in the active tab of the browser without intervention from the user. Thus, when the tab shortcut is selected, content returned as a result of the query is displayed in the newly opened tab. This technique eliminates even more interactions and provides even more content information in more computationally efficient manner. Thus, the techniques of the present disclosure improve the function and capabilities of web browser technologies.

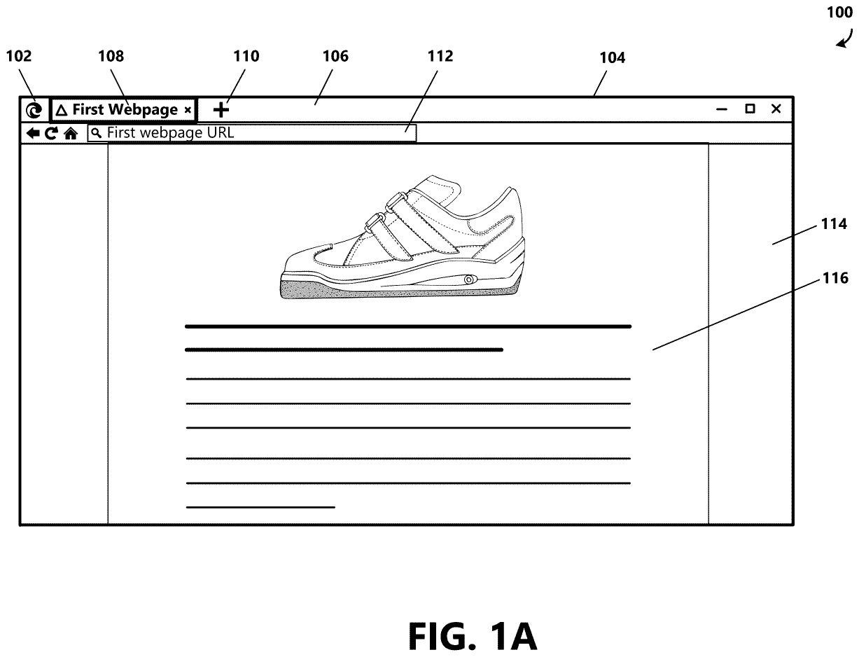

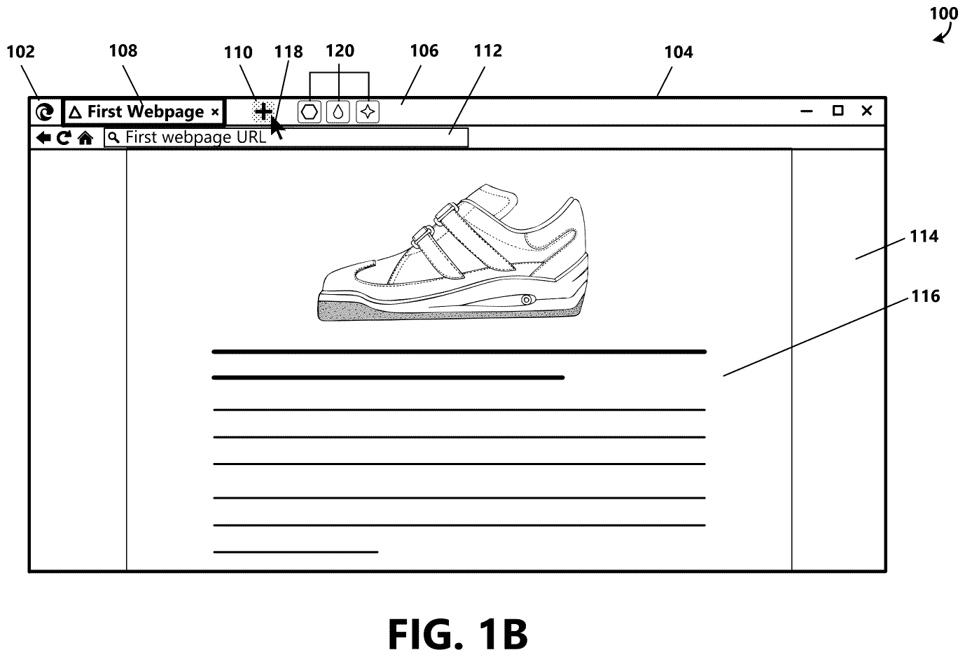

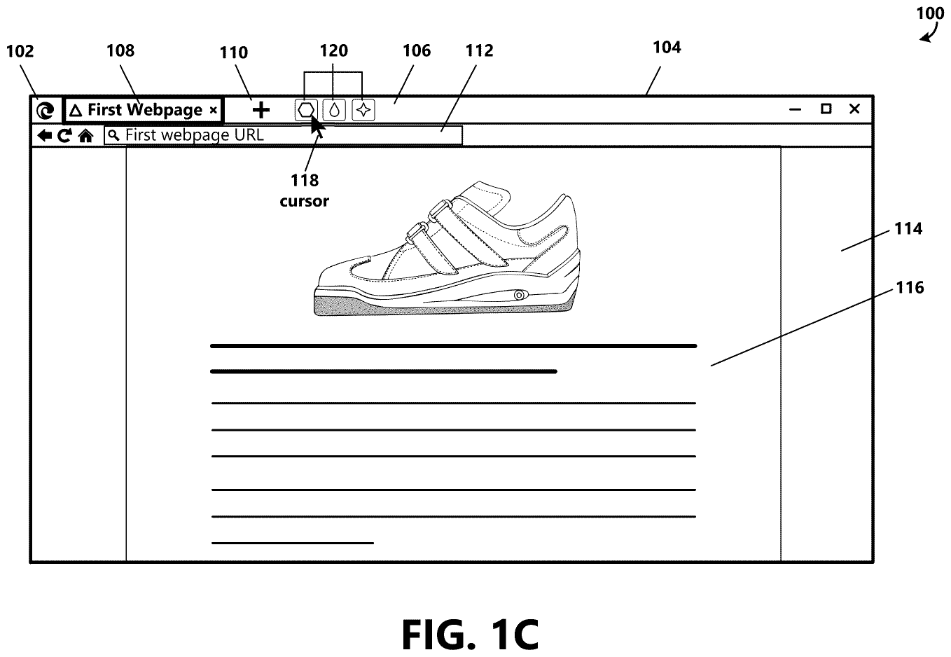

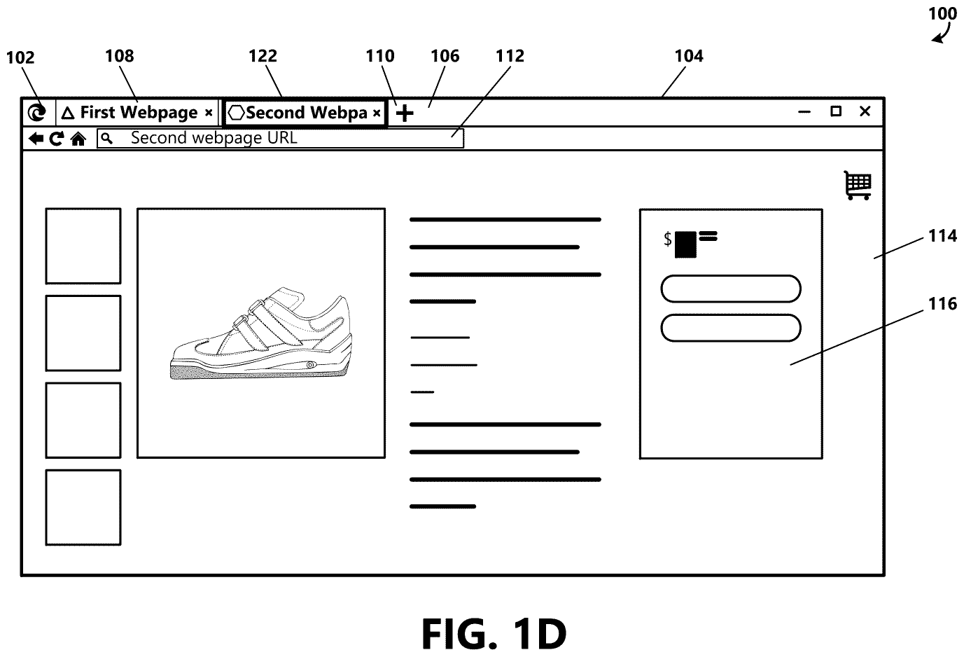

FIG. 1A depicts an example web browsing environment 100 including a web browser 102 having a framework for providing context-aware tab shortcut recommendations. A web browser application window 104 provides a user interface including various features of the web browser 102, such as a tabs container 106. The tabs container 106 is a region of the user interface of the web browser 102 in which one or more tabs 108 are displayed. The tabs container 106 may also be referred to as a tab bar. Tabs 108 correspond to web pages 116 that are open in the web browser 102. The example web browser 102 in FIG. 1A has one tab 108 open which corresponds to web page 116 that is open in the web browser 102. In some embodiments, a main display region 114 of the web browser 102 displays the web page 116 that has been loaded in the web browser 102. In some embodiments, the main display region 114 may be in an empty state if a web page has not yet been loaded in the web browser 102.

Within a single web browser application window 104, there may be multiple tabs 108 with respective loaded web pages 116 open at once. In some embodiments, one tab 108 may be “active” at a time. When a tab 108 is active, the corresponding web page 116 is displayed in the main display region 114 of the web browser 102 and in view. Other tabs 108 that are not the active tab may be referred to as inactive tabs. In some embodiments, other web pages 116 that correspond to inactive tabs may still be open (e.g., loaded in the web browser or earmarked) but are not in view. Thus, an “active tab” or “active web page” may be used interchangeably and refer to the content that is currently selected and displayed in the main display region 114 of the web browser 102. This may be the web page 116 that a user is currently viewing (e.g., looking at or interreacting with) or an empty state if a web page 116 has not been loaded for the active tab. As mentioned, each web page 116 has a corresponding tab 108 displayed in the tabs container 106. In some embodiments, the tabs for each open web page 116, including inactive tabs, are visible even when the corresponding web pages 116 are not in view. Thus, a user can easily navigate to another web page 116 by clicking on the respective tab 108, which brings the corresponding web page 116 into view.

The interface of the web browser 102 further includes an interface element for opening a new page in the web browser application window 104, such as a new-tab button 110. When a selection of the new tab button 110 is received, a new tab 108 is displayed in the tabs container 106. In some embodiments, the new tab 108 becomes the active tab by default. In some embodiments, a default web page 116 (e.g., browser home page) may be displayed in the main display region 114 when a new tab 108 is opened. In some embodiments, the new-tab button 110 may be located next to the current tabs 108 in the tabs container 106, outside of the tabs container 106, or elsewhere in the web browser application window 104. In some embodiments, a new page may be opened by other means, for instance by voice command, hot key, or other accessibility means.

The web browser application window 104 also includes a search or uniform resource locator (URL) bar 112. The URL bar 112 is an input field that a user can use to submit the URL of the web page they would like to view. In some embodiments, the URL bar 112 also acts as a search bar which accepts a search query. If the input to the URL bar 112 is detected to be a URL, then the web browser 102 opens the web page associated with the URL in the active page. If the input to the URL bar 112 is detected to be a search query (e.g., not a URL), then the web browser 102 accesses a default search engine or service, provides the search query, and returns the results page of the search engine as the web page 116 displayed in the active page of the web browser 102. The web browser application window 104 also includes other user interface elements, such as a back, reload, and home buttons for navigating, manipulating, or otherwise utilizing the web browser 102.

FIG. 1B depicts the web browsing environment 100 with a framework for providing context-aware tab shortcut recommendations, in which a cursor 118 is hovering over the new tab button 110. In accordance with embodiments of the present disclosure, when the cursor 118 hovers over the new tab button 110, one or more recommended tab shortcuts 120 are displayed in the tabs container 106. In some embodiments, the tab shortcuts 120 are displayed next to the new tab button 110, as illustrated in FIG. 1B, for ease of access. The tab shortcuts 120 represent web pages that are predicted to be relevant or useful to the user based on the content of the active web page 116, and thus recommended. In some embodiments, the recommended web pages are anticipatory, and represent web pages the user might visit next.

In the illustrated example, the active web page 116 may be an article or blog post about a certain product such as a shoe. The content of this web page 116 may include content that is visible to the user, such as text and images. However, web page content may also include information that is not visible to the user, such as tags, metadata, and other information embedded in the code of the web page accessible by the web browser. Any web page content may be used in determining the recommended web pages. If there are multiple tabs 108 open in the web browser 102, and the user switches to another tab 108, thus changing the active tab 108, the tab shortcuts 120 are updated to reflect the web page 116 of the current active tab 108.

In the illustrated example, an example recommended web page may include a shopping website that carries the shoe featured in the active web page 116. Another example of a recommended web page may be a video featuring a review of the shoe. Another example may be a web page featuring additional information about the shoe. Another example may be a web page featuring similar shoes or other matching clothing articles. In some embodiments, the recommended web pages are selected not only based on the content of the active web page, but also based on the user's profile data. There are numerous ways of selecting the recommended web pages, some non-limiting examples of which are further below in the present disclosure.

In some embodiments, the tab shortcuts 120 include the favicons (or other graphical indicators) of the corresponding web pages. In some embodiments, the tab shortcuts 120 are displayed as long as the cursor 118 is hovering over the new tab button 110 and are removed from view when the cursor 118 moves away from the tabs container 106 or designated subregion of the tabs container 106. Despite the presence of the tab shortcuts 120, if the new tab button 110 is selected, a new tab 108 is opened as normal. In some embodiments, the tab shortcuts 120 may be displayed if the cursor is anywhere within the tabs container 106. In some embodiments, the tab shortcuts 120 may be displayed regardless of the position of the cursor 118. In some embodiments, the displaying of the new tab shortcuts 120 may be triggered by other means, such as voice command, hot keys, among others. The example in FIG. 1B shows three tab shortcuts 120. In other embodiments, more or fewer tab shortcuts may be displayed. In some embodiments, the number of tab shortcuts may be determined by various factors, such as a predefined number, the amount of space available in the tabs container 106, the number of relevant web pages available, among others.

FIG. 1C depicts the web browsing environment 100 with a framework for providing context-aware tab shortcut recommendations, in which the recommended tab shortcuts 120 are being displayed and a selection of one of the tab shortcuts 120 is about to be received. As illustrated, the cursor 118 is hovering over one of the tab shortcuts 120. FIG. 1D depicts the web browsing environment 100, in which the tab shortcut 120 from FIG. 1C has been selected (e.g., clicked on). When the user selects one of the tab shortcuts 120, a new tab 122 with the corresponding web page 124 is opened in the web browser 102. The new web page 124 also becomes the active web page in the web browser 102. The new tab 122 is displayed in the tabs container 106. In the illustrated example, the selected tab shortcut links to a product page of a shopping website featuring the shoe from the article in the previously active web page, represented by tab 108. The tab shortcuts 120 allow for directly accessing this product page 124 without needing to open a new empty page, navigate to the shopping site, and search for the particular shoe.

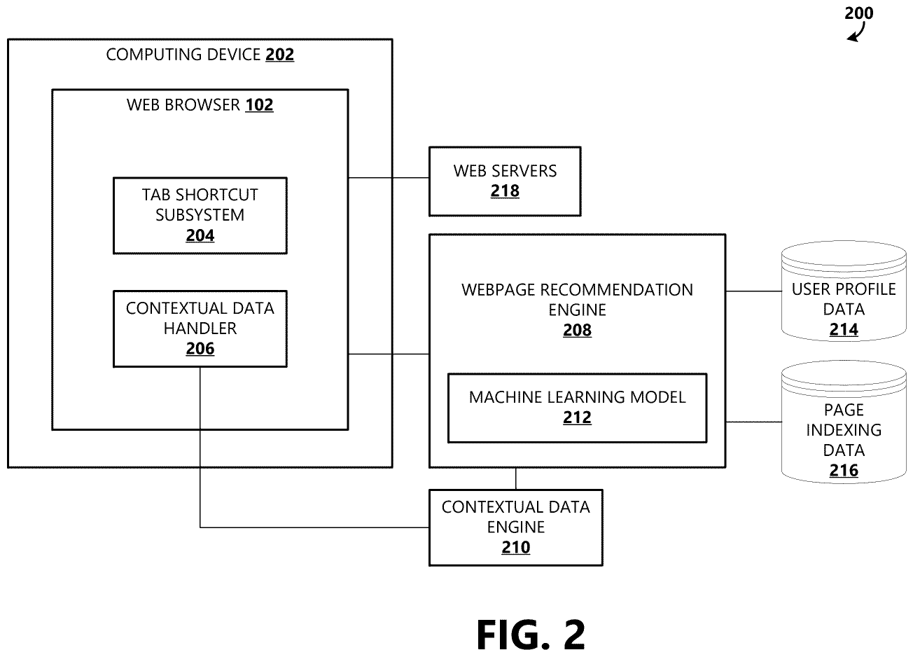

FIG. 2 depicts an example system 200 for implementing the framework for providing context-aware browser tab recommendations. A web browser 102 installed on a computing device 202 includes web browsing and display functionality that controls the retrieval and display of web pages 116 from remote sources, such as web servers 218. For instance, when a web page 116 is requested via a URL, the web browsing and display functionality receives the web page content from a web server 218 and displays the content in the web browser 102. Web servers 218 may also provide applications, services, data, etc. to the web browser 102 and/or computing device 202.

The web browser 102 further includes a tab shortcut subsystem 204 which manages the displaying of tab shortcuts 120. In some embodiments, the tab shortcut subsystem 204 utilizes listener functions of the web browser 102 to detect a hover event over (e.g., mouse over, long press) the new tab button 110 of the web browser 102 and the hover event ends (e.g., when the cursor moves out of or away from the new tab button 110) in order to determine when to display the tab shortcuts 120. In some embodiments, the tab shortcut subsystem 204 renders the tab shortcuts 120, including obtaining and displaying the favicons associated with the recommended web pages. The tab shortcut subsystem 204 may monitor switching between tabs 108 in the web browser 102 to determine the active page. In some embodiments, when the tab shortcut subsystem 204 detects a change in the active page, the tab shortcut subsystem 204 triggers a process to update the recommended web pages and the tab shortcuts 120 accordingly for the contents of the currently active page.

The web browser 102 further includes a contextual data handler 206. In some examples, a contextual data handler 206 manages different types of contextual data. An example instance of a contextual data handler 206 extracts context from the web page(s) 116 that are displayed by the web browser 102. The contextual data handler 206 may extract different types of data from different types of web pages. For example, the contextual data handler 206 may utilize algorithms and machine learning (ML) models to determine what type of content is displayed on the web page and determine what type of data to extract or interpret. For example, the contextual data handler 206 may extract a first type of context from a first web page, and a further example contextual data handler 206 extracts a second type of context from a second web page. In some examples, text corresponding to entities is extracted from content displayed in a web page 116 in the web browser 102 and categorized and/or classified according to a ML model and/or through named entity recognition (NER) algorithms. In some examples, the ML models include Open Neural Network Exchange (ONNX) ML models or the like. For instance, entities are extracted from the text, images, code, and other content of the web page 116. The extracted entities and/or their classifications/categorizations are a type of context. Other types of context can be extracted from content of a web page 116. Other context types may be based on user segmentation, browser history, cookies, regular expression (regex) queries, image content recognizers (e.g., objects recognized in images), video context recognizers (e.g., text from subtitles, objects recognized in video), and/or other data extracted from web page content. It should be noted that web page content can refer to any content or data associated with the web page 116 that the web browser 102 has access to, including content or data that is not displayed to the user, such as metadata, embedded tags, attributes, links, resources, APIs, among others. In some embodiments, various functions of the contextual data handler 206 may be performed by a server remote from the computer device 202, such as a contextual data engine 210. The contextual data engine 210 may be a remote service that communicates with the contextual data handler 206 to process or interpret content in a web page to determine one or more pieces of contextual data for the web page 116, including the aforementioned entity data.

In some embodiments, the contextual data handler 206 may detect a tagged accelerator element in the code of a web page 116 in a web browser 102. A tagged accelerator element may include information in the code (e.g., Hypertext Markup Language (HTML)) of the web page 116 that is designated for the purpose of determining relevant web pages for tab shortcuts 120. For example, there may be a tag in the header (or other segment) of the web page 116 that includes certain keywords or phrases. The tagged accelerator element may also include a direct link to a web page for a tab shortcut 120. In another example, an image link may be tagged to indicate that the image is to be used for determining relevant web pages, such as for an image search. In some embodiments, the tagged text may be updated or generated dynamically based on the user or user behavior on the web page. For example, the web page may be an article that features several products. The attribute value of a tagged element, such as a link to a product page on a shopping site may be updated to reflect the product that is currently in view.

The system 200 for providing context-aware browser tab recommendations further includes a web page recommendation engine 208. The web page recommendation engine 208 utilizes various types of data to determine one or more relevant web pages to recommend to the user via the tab shortcuts 120, based on the active web page 116 in the web browser 102. In some embodiments, the web page recommendation engine 208 receives contextual information from the contextual data handler 206. In some embodiments, the web page recommendation engine 208 receives contextual information from the contextual data engine 210. As an example, the contextual data engine may summarize a web page through ML or artificial intelligence (AI) models. For example, in the example illustrated in FIG. 1A, if the web page is an article about various products, the contextual data may include data indicating that the article is about shoppable products, type of products featured, a list of the products featured in the article, including their brands, prices, images, sentiment reflected by the text, among others. In some embodiments, the contextual information includes or is derived from embedded data extracted from front-end code of the active web page.

Utilizing the contextual data of the active web page 116, the web page recommendation engine 208 attempts to predict which other web pages the user is likely to be interested in. For example, since the contextual data includes information that the active web page 116 features shoppable products, and the type of products is shoes, the web page recommendation engine 208 may suggest a website that sells the shoes. In some embodiments, the web page recommendation engine 208 may conduct a general search utilizing a search engine to find websites that are most relevant. For example, the web page recommendation engine 208 may search for a specific shoe featured in the article using the contextual information (e.g., brand, product name, image) as search parameters to find e-commerce sites that carry the shoe. Conversely, if the active web page 116 is a product page of an e-commerce site, the web page recommendation engine 208 may search for and suggest a web page with an article or review of the product.

In some embodiments, the web page recommendation engine 208 may receive user profile data 214 for the current user to further refine the web page recommendations for the current user. The user profile data 214 may include various information specific to the user. For example, user profile data 214 may include demographic information and browsing history. Demographic information may include age, gender, language, location, device type, among others. Browsing history may include previously visited web pages as well as interaction data about those visits such as time spent, scroll information, interactions make on the page, shares, links clicked, add to cart, purchases, among others. For example, a user may have a history of making purchases at a particular e-commerce site. The web page recommendation engine 208 may recommend a product page at the favored e-commerce site as opposed to a product page for the same product at an e-commerce site that the user does not have a history of visiting. The user profile data 214 is specific to each user and may be used to further refine recommendations for the individual user. In some embodiments, user profile data 214 may or may not be available for the current user. For example, user profile data 214 may not be available if the user is a new user and has not set up a profile and/or there is no historical browsing data available. A user may also have turned off the option to utilize user profile data 214 for services as a part of a setting of the web browser 102.

In some embodiments, the web page recommendation engine 208 may receive page indexing data 216 from a page indexing source. The page indexing data 216 may include web pages that users tend to visit after visiting the active web page 116. Thus, the web page recommendation engine 208 may utilize the page indexing data in determining the relevant web pages to recommend.

The web page recommendation engine 208 may base the recommended web pages on any combination or weighing of contextual data extracted from the active web page, page indexing data, and user profile data. In some embodiments, the web page recommendation engine 208 utilizes a machine learning model 212 to assist in determining web pages to recommend for the tab shortcuts 120. The machine learning model 212 may be defined may be trained on various types of training data, including contextual data, user profile data, and quality of recommended web pages with respect to contextual data and user profile data.

Quality of a particular recommended web page may be evaluated (e.g., scored) based on whether and the degree to which the user interacts with the recommended web page. For example, the quality metric may be based on whether the user clicks on the tab shortcut 120 for the recommended web page, how much time the user spends on the recommended web page, whether the user takes further action on the recommended web page (e.g., link click, add to cart, purchase, scrolling time), among others. For example, if the recommended web page is opened and quickly navigated away, that may be an indication that the quality of the web page was not high for that user or context. This data may be collected with reference to the user's profile data 214 and used to continuously train the machine learning model in order to optimize the quality or relevance of the recommended web pages for each user. Thus, in some embodiments, the contextual information and/or the user profile data 214 is processed through the machine learning model 212, and the recommended web pages are determined based at least in part on an output of the machine learning model 212.

Additionally, the recommended web pages may be determined not only based on the content in the current active tab, but also based on other open tabs in the browser or recently closed tabs (e.g., during a current browsing session or instance of the web browser). For example, a web page may not be recommended as a new tab shortcut 120 if the web page is already open in another tab in the browser, or if the web page was recently visited and closed. Thus, in some embodiments, there is a filtering stage in which certain web page that would have otherwise been recommended web pages are filtered out based on one or more criteria.

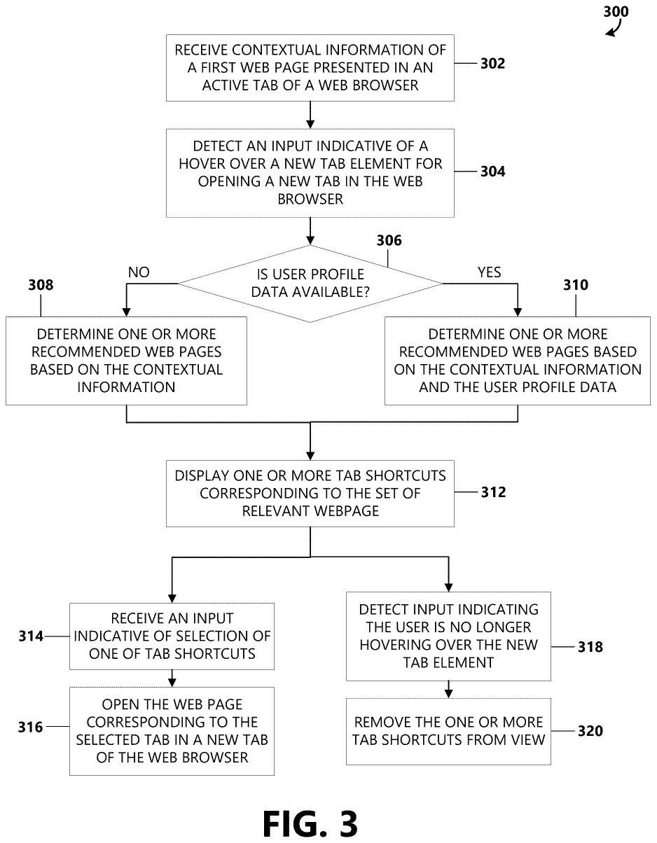

FIG. 3 depicts an example method 300 for utilizing the framework for providing context-aware browser tab recommendations. The operations of method 300 are performed by a computing device, such as a computing device 202 hosting a web browser 102 or a remote server providing the framework. It should be noted that the operations in FIGS. 3-6 may be performed in any order and/or some of the operations may be performed concurrently. At operation 302, contextual information related to a first web page 116 presented in an active tab 108 of a web browser 102 is received. In some embodiments, the contextual information may be received from the contextual data handler 206 of the contextual data engine 210. The contextual information may include various types of information. In some embodiments, the types of information included in the contextual information for a particular web page 116 may depend on the type of content in the web page 116. For example, in some embodiments, the content of a web page 116 may be analyzed by an entity extraction engine or service. The entity extraction engine may determine specific relevant information about the contents of the web page, such as topic, products, price, among others.

In some embodiments, the contextual information may include tagged data in the code of the active web page 116. The tagged data may include conventional html tags or specific tags that designate specific information be used for the purpose of generating tab shortcuts 120. For example, the tagged data may include keywords or other text that can be used in determining recommended web pages. In some embodiments, the contextual information may include tagged links which directly provide links to web pages for tab shortcuts. In some embodiments, a tagged link may be displayed on the web page 116, selectable by the user. In some embodiments, a tagged link may not be displayed on the web page 116 to the user. In some embodiments, the contextual information may include one or more related web pages received from a page indexing service. For example, a page indexing service may have records of web pages that users often visit after visiting the active web page 116, or web pages with which users tend to engage positively (e.g., share, purchase, dwell) after visiting the active web page 116. This information can provide useful insight for predicting web pages that a user may find useful and like to visit next. As mentioned, the contextual information may include various types of information received from various sources that may be helpful in predicting relevant web pages.

At operation 304, an input indicative of a hover (e.g., mouse over, long press) over an interface element for opening a new page in the web browser 102 is detected. This may include a cursor hovering over a new tab button 110 in the web browser application window 104. In some embodiments, this action triggers other steps for generating tab shortcuts 120. Operation 302 may be performed before, after, or concurrently with operation 304. In some embodiments, operation 302 is partially performed before operation 304 and partially after operation 304.

At operation 306, it is determined whether user profile data 214 is available for the current user. User profile data 214 may include various information specific to the user. For example, user profile data 214 may include demographic information and browsing history. Demographic information may include age, gender, language, location, device type, among others. Browsing history may include previously visited web pages as well as interaction data about those visits such as time spent, scroll tracking, interactions made on the page, shares, links clicked, add to cart, purchases, among others. The user profile data 214 is specific to each user and may be used to further refine web page recommendations for the individual user. In some embodiments, user profile data 214 may or may not be available for the current user. For example, user profile data 214 may not be available if the user is a new user and has not set up a profile, and there is no historical browsing data. A user may also have turned off the option to utilize user profile data 214 for services as a part of the setting on the web browser 102. If user profile data 214 is not available for the current user, operation 308 occurs, in which one or more recommended web pages are determined based on the contextual information of the active web page 116, and does not utilize specific user profile data. If user profile data 214 is available, operation 310 occurs, in which one or more recommended web pages are determined based on the contextual information and the user profile data 214. Thus, the selected web pages are further personalized (i.e., filtered) for the specific user when user profile data 214 is available.

At operation 312, one or more tab shortcuts 120 corresponding to the recommended web pages are displayed, such as in the tabs container 106 of the web browser application window 104. At operation 314, an input (e.g., click) indicative of selection of one of the tab shortcuts 120 is received, which leads to operation 316, in which the web page corresponding to the selected tab shortcut is opened in a new tab 122 of the web browser 102. Alternatively, in some embodiments, the cursor 118 may be moved away from the new tab button 110 without making a selection. At operation 318, it is detected that the user is no longer hovering over the new tab button 110. Accordingly, operation 320 occurs, in which the one or more tab shortcuts 120 are removed from view. In this example embodiment, the tab shortcuts 120 are only displayed when the user hovers over the new tab button 110. In other embodiments, the tab shortcuts 120 may be displayed or removed from view according to other types of triggers. In some embodiments, the tab shortcuts 120 may persistently be in view.

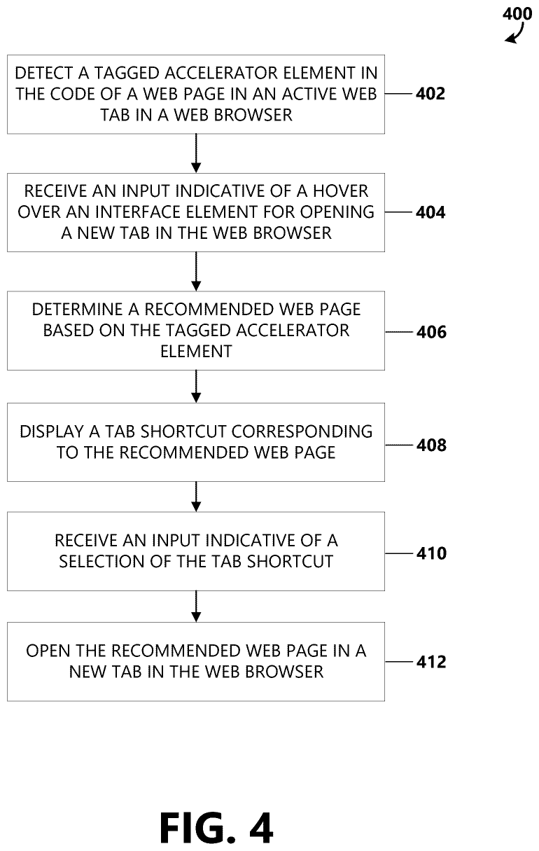

FIG. 4 depicts another example method for utilizing the framework for providing context-aware browser tab recommendations. At operation 402, a tagged accelerator element is detected in the code of an active web page 116 in a web browser 102. A tagged accelerator element may include information in the code (e.g., html) of the web page 116 that is designated for the purpose of determining relevant web pages for tab shortcuts 120. For example, there may be a tag in the header (or other section) of the web page 116 that includes certain keywords or phrases. The tagged accelerator element may also include a direct link to a web page for a tab shortcut 120. In another example, an image link may be tagged to indicate that the image is to be used for determining relevant web pages, such as for an image search. In some embodiments, the tagged text may be updated or generated dynamically based on the user or user behavior on the web page. For example, the active web page 116 may be an article that features several products. The attribute value of a tagged element, such as a link to a product page on a shopping site, may updated to reflect the product that is currently in view.

At operation 404, an input is received which indicates a hover over a new tab button 110 in the web browser 102. At operation 406, a web page is determined based on the content of the tagged accelerator element. As mentioned, in an example in which the tagged accelerator element includes a link to a web page, the determined web page is simply the web page at the tagged link. In some embodiments, the tagged accelerator element includes a keyword or text that is used to determine the web page. In some embodiments, other contextual information and/or user profile data may also be used in determining the web page. At operation 408, a tab shortcut 120 corresponding to the web page is displayed, such as in the tabs container 106 of the web browser application window 104. At operation 410, an input indicative of a selection of the tab shortcut 120 (e.g., click) is received. At operation 412, the recommended web page is opened in a new tab in the web browser 102.

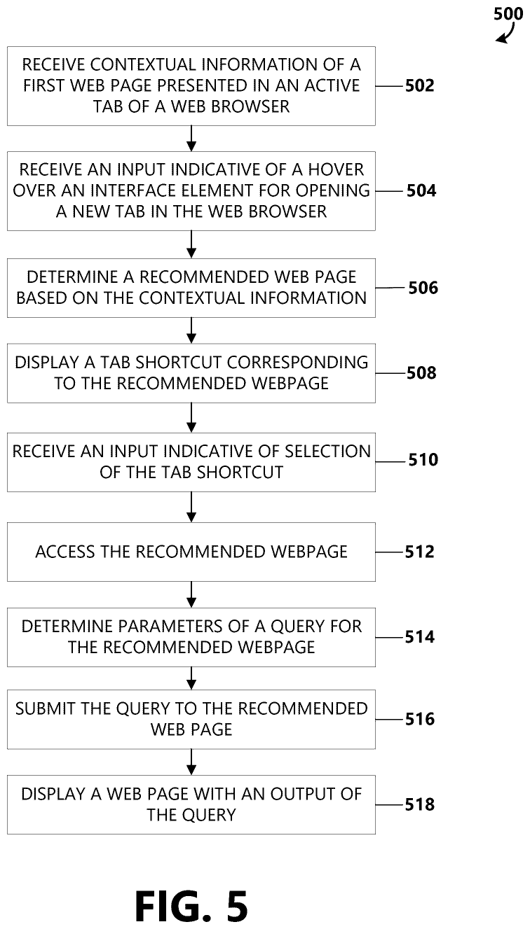

FIG. 5 depicts another example method for utilizing the framework for providing context-aware browser tab recommendations, in which a query is automatically entered into a recommended web page. At operation 502, contextual information related to a first web page 116 presented in an active tab 108 of a web browser 102 is received. At operation 504, an input indicative of a hover over an interface element for opening a new page in the web browser 102 is detected. This may include a cursor hovering over a new tab button in the web browser application frame. In some embodiments, this action triggers other steps for providing recommended tab shortcuts 120. In some embodiments, operation 502 may be performed before, after, or concurrently with operation 504. In some embodiments, operation 502 is partially performed before operation 504 and partially after operation 504.

At operation 506, a relevant web page is determined based at least in part on the contextual information of the active web page 116 in the web browser 102. In some embodiments, user profile data 214 such as demographic information and/or browsing history may also be used to further refine to optimize the web page recommendation for the specific user.

At operation 508, a tab shortcut 120 corresponding to the recommended web page is displayed in the tabs container 106 of the web browser 102 when the user hovers over the new tab button 110. In some embodiments, the tab shortcut 120 may include a favicon of the web page so that the user may recognize what website the web page belongs to. At operation 510, a selection (e.g., click) of the tab shortcut 120 is received. At operation 512, the recommended web page is accessed. The web page may include one or more input fields for accepting a query or other form of input. For example, the recommended web page may be a website having a search functionality, such as a search engine or e-commerce site. In another example, the recommended web page may be an AI-powered chat service that accepts questions, instructions, or other prompts.

At operation 514, parameters of a query to be provided as input to the recommended web page are determined. The parameters may include a keyword, a number, an alphanumeric string, a phrase, sentence, encoded data, link, image, among others. The parameters may be determined based at least in part on the contextual information of the active web page 116. In some embodiments, the parameters are directly embedded and/or tagged in the code of the active web page 116. Embodiments of the present disclosure are not limited to the example order of operations in the illustrated example of FIG. 5. For example, in another example, the parameters may be determined before the recommended web page is accessed.

At operation 516, the query is submitted as an input to the recommended web page 116. At operation 518, a web page having content returned as a result of the query submission is displayed in a new page in the web browser 102. In some embodiments, the web page displayed in operation 518 is the same web page as the recommended web page accessed in operation 512. In some embodiments, the web page displayed in operation 518 is a different same web page as the recommended web page accessed in operation 512. This may occur when submitting the query into the accessed web page causes another web page to be served.

For example, the initially accessed web page may be a homepage of an e-commerce site with a product search input, and the query may include a product name or id. When the user clicks on the tab shortcut, the homepage of the e-commerce site is accessed, and the query is entered into the search input and submitted automatically. This may cause the e-commerce site to leave the homepage and return a product page, which is displayed to the user in the new page of the web browser 102. In some embodiments, the initially accessed page may also be initially displayed in the new page when it is accessed. However, in some cases, the query may be submitted by the web browser 102 so quickly that the initially accessed page is replaced with the returned web page before it has fully rendered or loaded. Thus, the user may or may not see the initially accessed web page before the returned web page is displayed. In some embodiments, the content of the initial web page is accessed by the web browser 102 and the query submitted without rendering the web page for display. In this case, the first web page that is displayed to the user is the returned web page.

In another example, the recommended web page determined at operation 506 and accessed at operation 512 may be or include a generative AI service. In this example, the input or query submitted to the web page may include a prompt for the generative AI service, and the web page displayed at operation 518 may include an output from the generative AI service. For example, the generative AI service at or associated with the web page may be an AI-powered chatbot with an input for querying the chatbot. The query determined at operation 514 may be a question or prompt related to the content of the active web page 116. When the user clicks on the tab shortcut 120, the chatbot is accessed and the query is automatically submitted. The web page showing the response from the chatbot is displayed to the user in a new tab of the web browser 102. In some embodiments, depending on the speed at which the web page is rendered in the at the web browser and the speed at which the query is submitted and response is returned, the user might see the web page at any point during this process.

In some embodiments, when the tab shortcut 120 is selected, various types of actions may be triggered on the accessed web page. For example, a product may be added to a cart, an entry may be made or updated in a database associated with the web page, an API call may be made, among others. In some embodiments, the web page displayed in the new page of the web browser 102 at operation 518 may be a confirmation page that the action has been made.

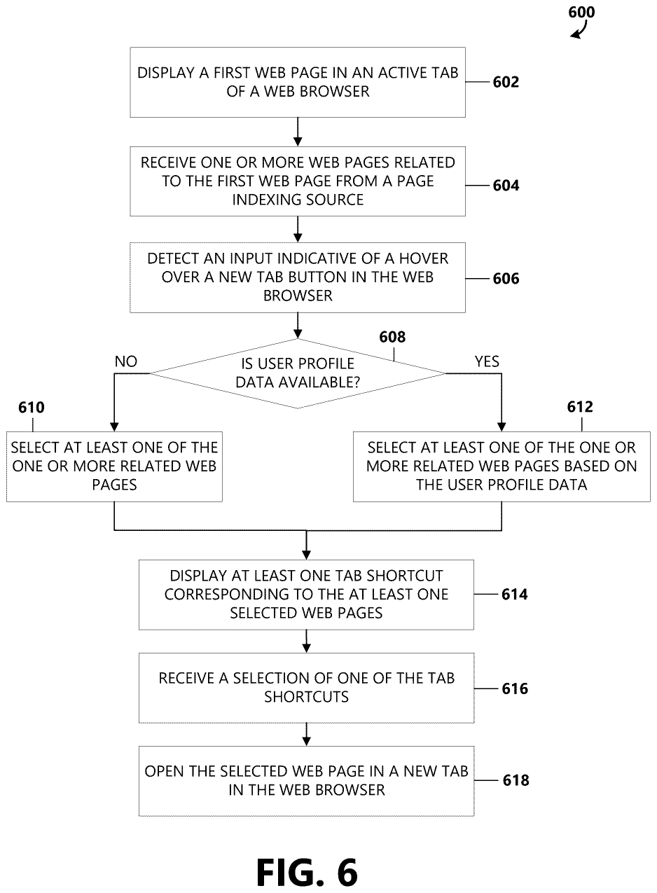

FIG. 6 depicts another example method for utilizing the framework for providing context-aware browser tab recommendations, in which the contextual information for determining recommended web pages includes data from a page indexing source. At operation 602, a first web page 116 is displayed in an active tab 108 of a web browser 102. At operation 604, one or more web pages related to the first web page 116 may be received from a page indexing source. The page indexing source can provide data that includes web pages that users tend to visit after visiting the first web page 116 displayed in the active tab 108. At operation 606, a user input indicative of a hover over the new tab button 110 is detected. At operation 608, it is determined whether user profile data 214 is available for the current user. User profile data 214 may include various information specific to the user. For example, user profile data 214 may include demographic information and browsing history. Demographic information may include age, gender, language, location, device type, among others. Browsing history may include previously visited web pages as well as interaction data about those visits such as time spent, scroll information, interactions make on the page, shares, links clicked, add to cart, purchases, among others.

The user profile data 214 is specific to each user and may be used to further refine recommendations for the individual user. In some embodiments, user profile data may or may not be available for the current user. If user profile data is not available for the current user, operation 610 occurs, in which at least one of the one or more related pages is selected based on the data from the page indexing source and without utilizing specific user profile data 214. If user profile data 214 is available, operation 612 occurs, in which at least one of the one or more related pages is selected based on the data from the page indexing source and specific user profile data 214. Thus, the selected web pages are further personalized (i.e., filtered) for the specific user. At operation 614, at least one tab shortcut 120 corresponding a related web page is displayed, such as in the tabs container 106 of the web browser application window 104. At operation 616, a user input (e.g., click) indicative of selection of one of the tab shortcuts 120 is received, which leads to operation 618, in which the related web page corresponding to the selected tab shortcut 120 is opened in a new page of the web browser 102.

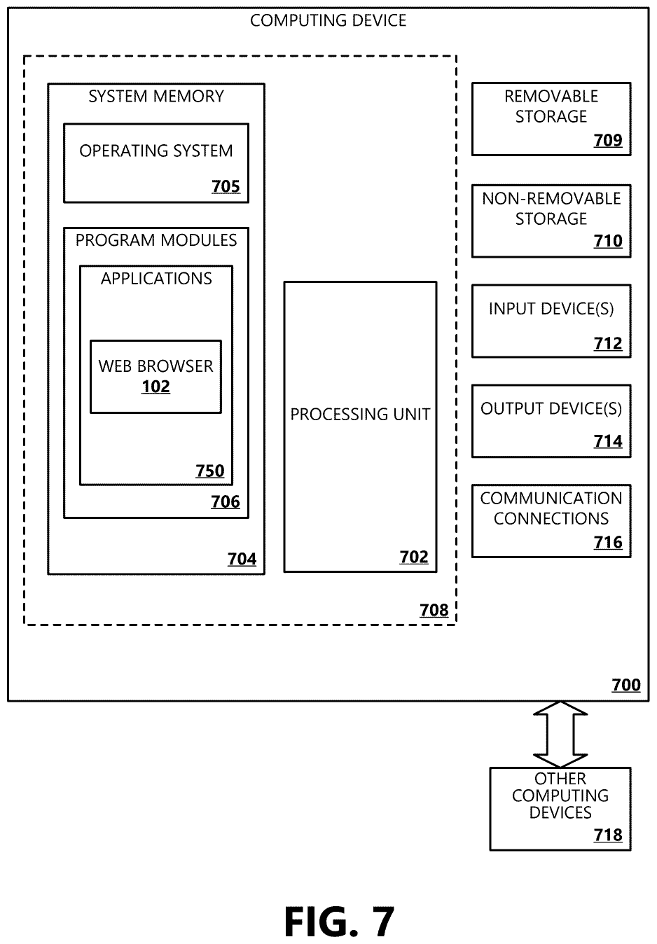

FIG. 7 and the associated description provide a discussion of a variety of operating environments in which examples of the invention may be practiced. However, the devices and systems illustrated and discussed with respect to FIG. 7 is for purposes of example and illustration and is not limiting of a vast number of computing device configurations that may be utilized for practicing aspects of the invention, described herein. FIG. 7 is a block diagram illustrating physical components (i.e., hardware) of a computing device 700 with which examples of the present disclosure may be practiced. The computing device components described below may be suitable for a client device running the web browser discussed above. In a basic configuration, the computing device 700 may include at least one processing unit 702 and a system memory 704. The processing unit(s) (e.g., processors) may be referred to as a processing system. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 750 such as a web browser 102 and one or more browser and/or non-browser desktop applications.

The operating system 705, for example, may be suitable for controlling the operation of the computing device 700. Furthermore, aspects of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including, but not limited to, one or more of the operations of the methods illustrated in FIGS. 3-6. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 700 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In an aspect, the present technology relates to a computer-implemented method for providing context-aware browser tab recommendations, comprising: receiving contextual information related to a first web page associated with an active tab of a web browser; detecting an input indicative of a hover over an interface element for opening a new tab in the web browser; determining, based at least in part on the contextual information, one or more recommended web pages; and displaying, in the web browser, one or more browser tab shortcuts corresponding to the one or more recommended web pages.

In some examples, the contextual information includes a link embedded in the first web page, and at least one of the one or more browser tabs shortcuts corresponds to the link.

In some examples, the contextual information includes embedded data extracted from front-end code of the first web page.

In some examples, the contextual information includes entity data determined from content of the first web page.

In some examples, the contextual information includes related web pages determined by a page indexing service.

In some examples, the method further comprises: receiving a selection of one of the one or more browser tab shortcuts, the selected browser tab shortcut corresponding to a selected web page of the one or more recommended web pages; and opening the selected web page in a new tab in the web browser.

In some examples, the method further comprises: receiving user profile data associated with a browsing session of the web browser; and determining the one or more recommended web pages based at least in part on at least a portion of the user profile data.

In some examples, the user profile data includes one or more of user demographic data, browsing history, and interaction data.

In some examples, the method further comprises: inputting the contextual information and the user profile data through a machine learning model trained to recommend web pages based on user profile data and contextual information of a web page; obtaining an output of the machine learning model; and determining the one or more recommended web pages based at least in part on the output of machine learning model.

In an aspect, the present technology relates to a system providing context-aware browser tab recommendations, the system comprising: a processing system; and memory storing instructions that, when executed by the processing system, cause the system to: display a first web page in a web browser, the web browser comprising an interface with a tabs container; determine contextual information associated with the first web page based on at least a portion of content in the first web page; process the contextual information through a recommendation engine trained to predict one or more web pages of interest based at least in part on the contextual information; and display one or more tab shortcuts in the tabs container, the one or more tab shortcuts corresponding to the one or more web pages of interest.

In some examples, the instructions further cause the system to: receive a selection of one of the one or more tab shortcuts; and open a new tab in the web browser, the new tab displaying a second web page corresponding to the selected tab shortcut.

In some examples, the instructions further cause the system to: determine a recommendation quality value associated with the second web page, the recommendation quality value determined at least in part based on user interactions with the second web page; and update the recommendation engine based on the recommendation quality value.

In some examples, the instructions further cause the system to: detect an input indicative of a user hovering over an interface element for opening a new tab in the web browser; and display the one or more tab shortcuts upon detecting the user input.

In some examples, the instructions further cause the system to: detect an end of the hovering over the interface element for opening a new tab; and remove the one or more tab shortcuts from view.

In some examples, the one or more tab shortcuts include favicons of the one or more web pages of interest, respectively.

In an aspect, the present technology relates to a system providing context-aware browser tab recommendations, the system comprising: a processing system; and memory storing instructions that, when executed by the processing system, cause the system to: receive contextual information related to a first web page associated with an active tab of a web browser; determine, based at least in part on the contextual information, a recommended web page; display, in the web browser, a browser tab shortcut corresponding to the recommended web page; receive a selection of the browser tab shortcut; access the recommended web page; submit an input to the recommended web page, the input determined based at least in part on the contextual information; and display a second web page, the second web page comprising content returned as a result submitting the input.

In some examples, the second web page is the same web page as the recommended web page.

In some examples, submitting the input to the recommended web page causes the second web page to be served, the second web page being different from the recommended web page.

In some examples, the input includes a search query, and the second web page includes results associated with the search query.

In some examples, the input includes a prompt into a generative artificial intelligence (AI) service, and the second web page includes an output from the generative AI service.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A computer-implemented method for providing context-aware browser tab recommendations, comprising:
receiving contextual information related to a first web page associated with an active tab of a web browser;
detecting an input indicative of a hover over an interface element for opening a new tab in the web browser;
determining, based at least in part on the contextual information, one or more recommended web pages; and
displaying, in the web browser, one or more browser tab shortcuts corresponding to the one or more recommended web pages.

2. The computer-implemented method of claim 1, wherein the contextual information includes a link embedded in the first web page, and at least one of the one or more browser tabs shortcuts corresponds to the link.

3. The computer-implemented method of claim 1, wherein the contextual information includes embedded data extracted from front-end code of the first web page.

4. The computer-implemented method of claim 1, wherein the contextual information includes entity data determined from content of the first web page.

5. The computer-implemented method of claim 1, wherein the contextual information includes related web pages determined by a page indexing service.

6. The computer-implemented method of claim 1, further comprising:
receiving a selection of one of the one or more browser tab shortcuts, the selected browser tab shortcut corresponding to a selected web page of the one or more recommended web pages; and
opening the selected web page in a new tab in the web browser.

7. The computer-implemented method of claim 1, further comprising:
receiving user profile data associated with a browsing session of the web browser; and
determining the one or more recommended web pages based at least in part on at least a portion of the user profile data.

8. The computer-implemented method of claim 7, wherein the user profile data includes one or more of user demographic data, browsing history, and interaction data.

9. The computer-implemented method of claim 7, further comprising:
inputting the contextual information and the user profile data through a machine learning model trained to recommend web pages based on user profile data and contextual information of a web page;
obtaining an output of the machine learning model; and
determining the one or more recommended web pages based at least in part on the output of machine learning model.

10. A system providing context-aware browser tab recommendations, the system comprising:
a processing system; and
memory storing instructions that, when executed by the processing system, cause the system to:
display a first web page in a web browser, the web browser comprising an interface with a tabs container;
determine contextual information associated with the first web page based on at least a portion of content in the first web page;
process the contextual information through a recommendation engine trained to predict one or more web pages of interest based at least in part on the contextual information; and
display one or more tab shortcuts in the tabs container, the one or more tab shortcuts corresponding to the one or more web pages of interest.

11. The system of claim 10, wherein the instructions further cause the system to:
receive a selection of one of the one or more tab shortcuts; and
open a new tab in the web browser, the new tab displaying a second web page corresponding to the selected tab shortcut.

12. The system of claim 11, wherein the instructions further cause the system to:
determine a recommendation quality value associated with the second web page, the recommendation quality value determined at least in part based on user interactions with the second web page; and
update the recommendation engine based on the recommendation quality value.

13. The system of claim 10, wherein the instructions further cause the system to:
detect an input indicative of a user hovering over an interface element for opening a new tab in the web browser; and
display the one or more tab shortcuts upon detecting the user input.

14. The system of claim 13, wherein the instructions further cause the system to:
detect an end of the hovering over the interface element for opening a new tab; and
remove the one or more tab shortcuts from view.

15. The system of claim 10, wherein the one or more tab shortcuts include favicons of the one or more web pages of interest, respectively.

16. A system providing context-aware browser tab recommendations, the system comprising:
a processing system; and
memory storing instructions that, when executed by the processing system, cause the system to:
receive contextual information related to a first web page associated with an active tab of a web browser;
determine, based at least in part on the contextual information, a recommended web page;
display, in the web browser, a browser tab shortcut corresponding to the recommended web page;
receive a selection of the browser tab shortcut;
access the recommended web page;
submit an input to the recommended web page, the input determined based at least in part on the contextual information; and
display a second web page, the second web page comprising content returned as a result submitting the input.

17. The system of claim 16, wherein the second web page is the same web page as the recommended web page.

18. The system of claim 16, wherein submitting the input to the recommended web page causes the second web page to be served, the second web page being different from the recommended web page.

19. The system of claim 16, wherein the input includes a search query, and the second web page includes results associated with the search query.

20. The system of claim 16, wherein the input includes a prompt into a generative artificial intelligence (AI) service, and the second web page includes an output from the generative AI service.
